(19) United States
(12) Patent Application Publication
(10) Pub. No.: US 2012/0028615 A1
(43) Pub. Date: Feb. 2, 2012

(54) TWO-WAY COMMUNICATION OF EVENTS BETWEEN A MOBILE DEVICE AND REMOTE CLIENT

(75) Inventors: Palani Sundaramurthy, Kirkland, WA (US); Ying Wu, Redmond, WA (US); Albert Liu, Bellevue, WA (US); Craig Stuart Skinner, Snohomish, WA (US); Michelle Lynn Holtmann, Covington, WA (US); Marcelo Horacio Guerra Hahn, Redmond, WA (US)

(73) Assignee: Microsoft Corporation, Redmond, WA (US)

(21) Appl. No.: 12/848,415

(22) Filed: Aug. 2, 2010

(51) Int. Cl. H04M 3/00; H04M 1/725; H04B 7/00

(52) U.S. Cl. 455/412.2; 455/68; 455/420

(57) ABSTRACT

The present application allows two-way communication between a remote client and a mobile device, such as a mobile phone. User's can be informed of phone events in real time, regardless of their proximity to the mobile device. A two-way communication link allows a remote client to communicate back to the mobile device to leverage the capabilities of the mobile device. For example, a mobile device can be controlled remotely to send a text message. In this way, third parties receive a text message from the mobile device itself, even though it is not in the user's possession.

### FIELD

The present application relates to mobile devices, such as mobile phones, and particularly to two-way communications with such mobile devices.

### BACKGROUND

Mobile devices are becoming the mainstay of personal communications. For example, mobile phones are used for voice communications, sending email messages, SMS messages and multimedia messages. At the same time, desktop computers and other devices are still used for work or projects that require more computing power, larger screens, and more user input.

For this reason, there are systems that allow communication between mobile phones and desktop computers, such as by connecting the mobile phone to a desktop computer and synchronizing the two. Other devices have allowed a desktop computer to be notified when the mobile phone is remotely positioned. For example, a user can log into a mobile phone account on the desktop computer and receive event information from the mobile phone. In this way, the user can be notified of events on the mobile phone, even if the user is at the office and left their phone at home. However, the user must then act on the event from the remote location by using a different phone or a desktop email account in order to respond to the events. With the phone at home, there is little the user can do to actually use the phone and its capabilities.

### SUMMARY

The present application allows two-way communication between a remote client and a mobile device, such as a mobile phone so that the mobile device can be controlled remotely. User's can be informed of phone events in real time, regardless of their proximity to the mobile device. A two-way communication link allows a remote client to communicate back to the mobile device to leverage the capabilities of the mobile device (e.g. modem, location and network capabilities). For example, a mobile device can be controlled remotely to send a text message. In this way, third parties can receive a text message from the mobile device itself, even though the mobile device is not in the user's possession.

The two-way communication link with the mobile device allows virtually any features available on the mobile device to be used remotely.

The foregoing and other objects, features, and advantages of the invention will become more apparent from the following detailed description, which proceeds with reference to the accompanying figures.

### BRIEF DESCRIPTION OF THE DRAWINGS

FIG. 1 is an exemplary block diagram of a mobile device.

FIG. 2 is an exemplary flowchart of a method for communicating with a mobile device.

FIG. 3 is another exemplary flowchart of a method for communicating with a mobile device.

FIG. 4 is an embodiment showing a mobile phone establishing a two-way communication link with a remote device.

FIG. 5 is an embodiment showing an application for monitoring events and a user interface for selecting triggering events.

FIG. 6 is an embodiment showing an alert being sent over a two-way communication link in response to detection of an event.

FIG. 7 is an embodiment showing the alert of FIG. 5 being received by the remote device and automatically displaying the alert for a user.

FIG. 8 is an embodiment showing user selection of a command and transmission of the command through the two-way communication link.

FIG. 9 is an embodiment showing a mobile device monitoring for commands from the remote device.

FIG. 10 is an embodiment showing the mobile device performing an action based on the command by sending a text message to a third-party user.

FIG. 11 is a flowchart of an embodiment that can be used on the mobile device for monitoring events and monitoring commands from a remote device.

FIG. 12 is a flowchart of an embodiment that can be used on a remote device for monitoring alerts and transmitting commands to a mobile device.

FIG. 13 shows a variety of devices in which the embodiments described herein can be used.

### DETAILED DESCRIPTION

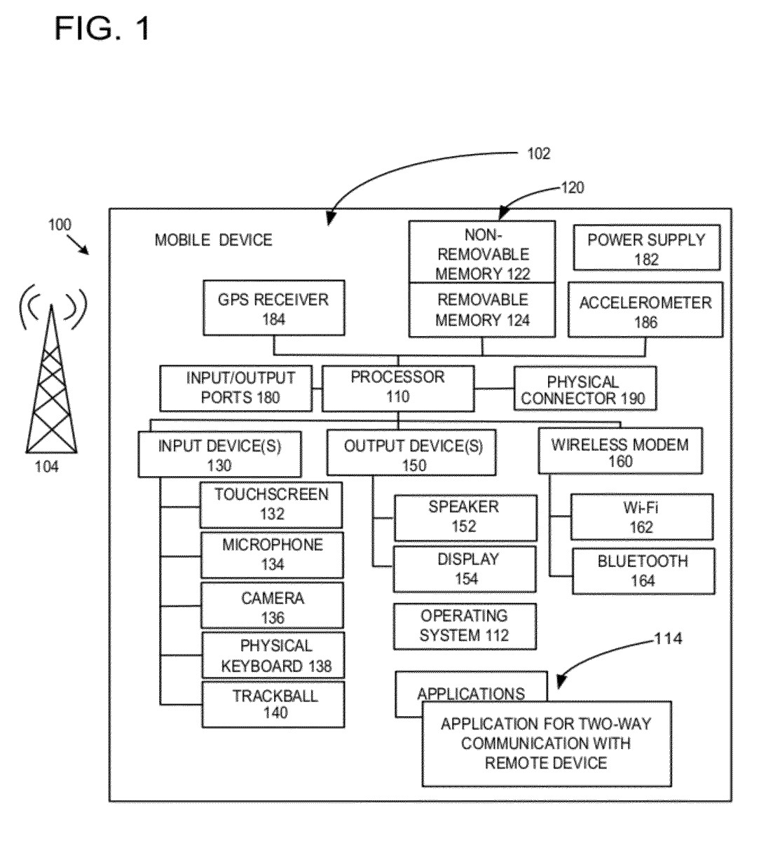

FIG. 1 is a system diagram depicting an exemplary mobile device 100 including a variety of optional hardware and software components, shown generally at 102. Any components 102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 104, such as a cellular or satellite network.

The illustrated mobile device 100 can include a controller or processor 110 (e.g., signal processor, microprocessor, ASIC, or other control and processing logic circuitry) for performing such tasks as signal coding, data processing, input/output processing, power control, and/or other functions. An operating system 112 can control the allocation and usage of the components 102 and support for one or more application programs 114. The application programs can include common mobile computing applications (e.g., email applications, calendars, contact managers, web browsers, messaging applications), or any other computing application. One application can allow for two-way communication with a remote device, as further described below.

The illustrated mobile device 100 can include memory 120. Memory 120 can include non-removable memory 122 and/or removable memory 124. The non-removable memory 122 can include RAM, ROM, flash memory, a hard disk, or other well-known memory storage technologies. The removable memory 124 can include flash memory or a Subscriber Identity Module (SIM) card, which is well known in GSM communication systems, or other well-known memory storage technologies, such as “smart cards.” The memory 120 can be used for storing data and/or code for running the operating system 112 and the applications 114. Example data can include web pages, text, images, sound files, video data, or other data sets to be sent to and/or received from one or more network servers or other devices via one or more wired or wireless networks. The memory 120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 100 can support one or more input devices 130, such as a touch screen 132, microphone 134, camera 136, physical keyboard 138 and/or trackball 140 and one or more output devices 150, such as a speaker 152 and a display 154. Other possible output devices (not shown) can include piezoelectric or other haptic output devices. Some devices can serve more than one input/output function. For example, touchscreen 132 and display 154 can be combined in a single input/output device.

A wireless modem 160 can be coupled to an antenna (not shown) and can support two-way communications between the processor 110 and external devices, as is well understood in the art. The modem 160 is shown generically and can include a cellular modem for communicating with the mobile communication network 104 and/or other radio-based modems (e.g., Bluetooth or Wi-Fi). The wireless modem 160 is typically configured for communication with one or more cellular networks, such as a GSM network for data and voice communications within a single cellular network, between cellular networks, or between the mobile device and a public switched telephone network (PSTN).

The mobile device can further include at least one input/output port 180, a power supply 182, a satellite navigation system receiver 184, such as a Global Positioning System (GPS) receiver, an accelerometer 186, and/or a physical connector 190, which can be a USB port, IEEE 1394 (FireWire) port, and/or RS-232 port. The illustrated components 102 are not required or all-inclusive, as any components can deleted and other components can be added.

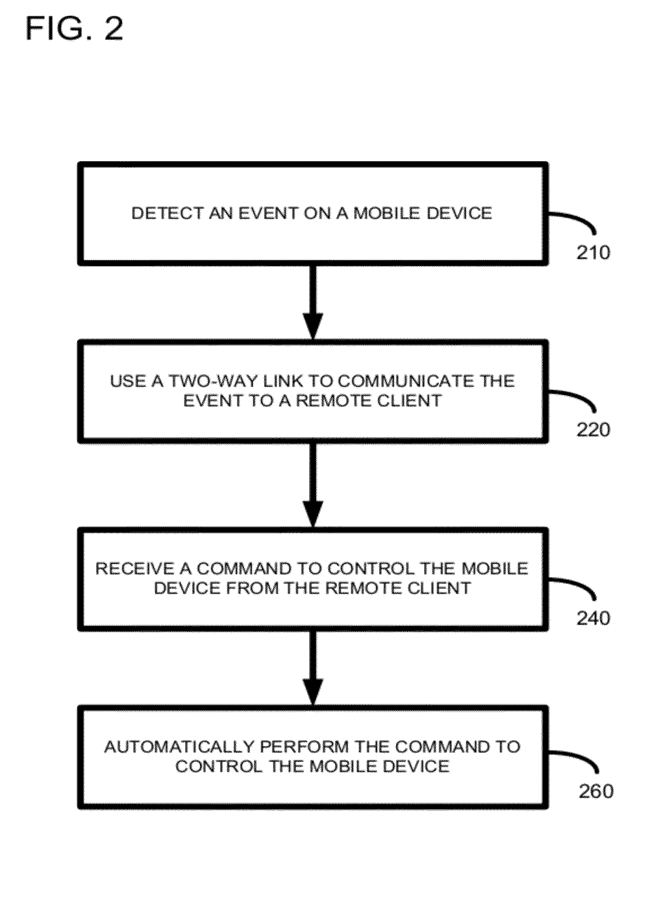

FIG. 2 is a flowchart of an embodiment for communicating with a mobile device. In process block 210, an event is detected in a mobile device, such as a mobile phone. An event can be a wide variety of mobile device activity that occurs. For example, an event can be a received SMS, email, phone call, calendar reminder, low battery indicator, new voice mail, location, network status ETC. Thus, events can be based on received activity or internally generated activity. Other events can also be used. In process block 220, a two-way communication link is used to communicate the event to a remote client. The remote client can be a personal computer, gaming console, connected TV, PDA, laptop, etc. The two-way communication can be established using a network, such as the Internet, or a peer-to-peer link, or some other communication channel. The event can be communicated automatically without user intervention. In process block 240, a command is received from remote client in order to control the mobile device. Thus, communication can occur from the mobile device to the remote client and vice versa. In process block 260, the command can be automatically performed on the mobile device, without the need for additional user interaction. In one example, the mobile device can be a mobile phone that the user left at home or work and a user can remotely control the mobile phone. The command can be performed by modifying settings of the device, sending messages to third parties using the cellular modem of the mobile device, etc. Virtually anything that can be performed on the mobile phone can be controlled remotely.

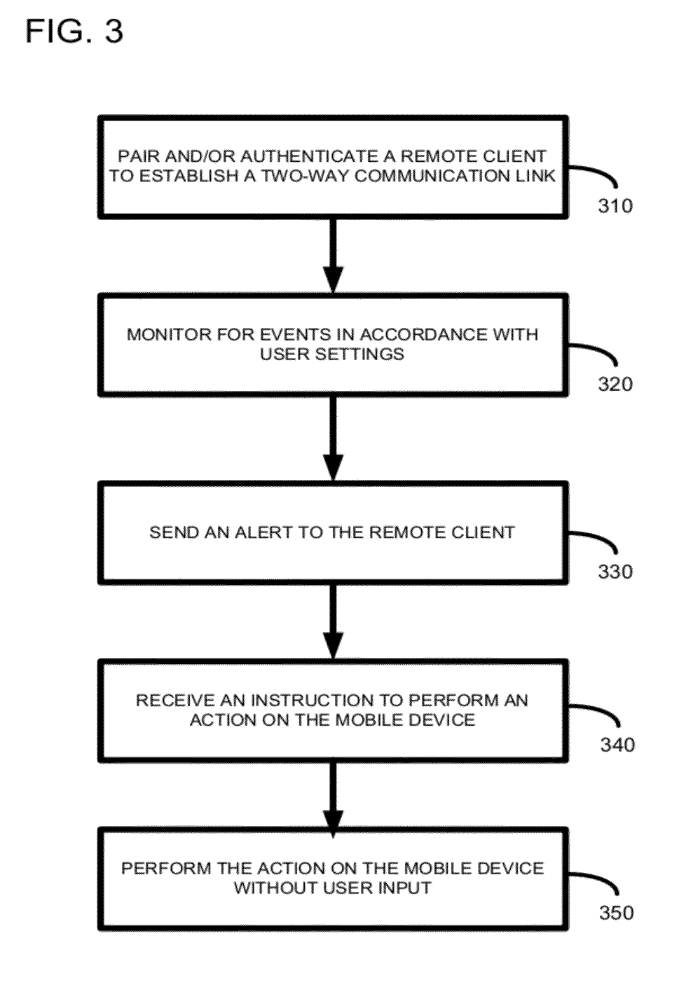

FIG. 3 is a flowchart of another embodiment for communicating with a mobile device. In process block 310, a two-way communication link can be established between a mobile device and a remote client. A process of pairing and/or authentication can be used is order to establish the link. Pairing can be legacy pairing or secure simple pairing (SSP). Other pairing methods can also be used. Additionally, any desired authentication method can be used. In process block 320, the mobile device monitors for events in accordance with user settings. Specifically, the user can control which events will be monitored by selecting events in a user interface. Any activity that occurs on the mobile phone is classified as an event and that event is compared to the events selected in the user interface. If there is a match between the two, then an alert is sent (process block 330) to the remote client using the two-way communication link. The alert can take any form of message, but generally includes information necessary for interpreting what event occurred. Once an alert is received at the remote client, the remote client typically takes some action in response to the alert, such as sending an instruction or command back to the mobile device. In process block 340, an instruction is received on the mobile device. The instruction directs the mobile device to perform an action, such as change settings on the phone (e.g., set up call forwarding, read or reply to an e-mail/text message, broadcast location, roaming status and other network information, change ring tones, time & date, address information, calendar, events, etc.) or send a text message, email, or voicemail. In process block 350, the action is carried out on the mobile device without any further user input. Thus, the mobile device can be controlled remotely.

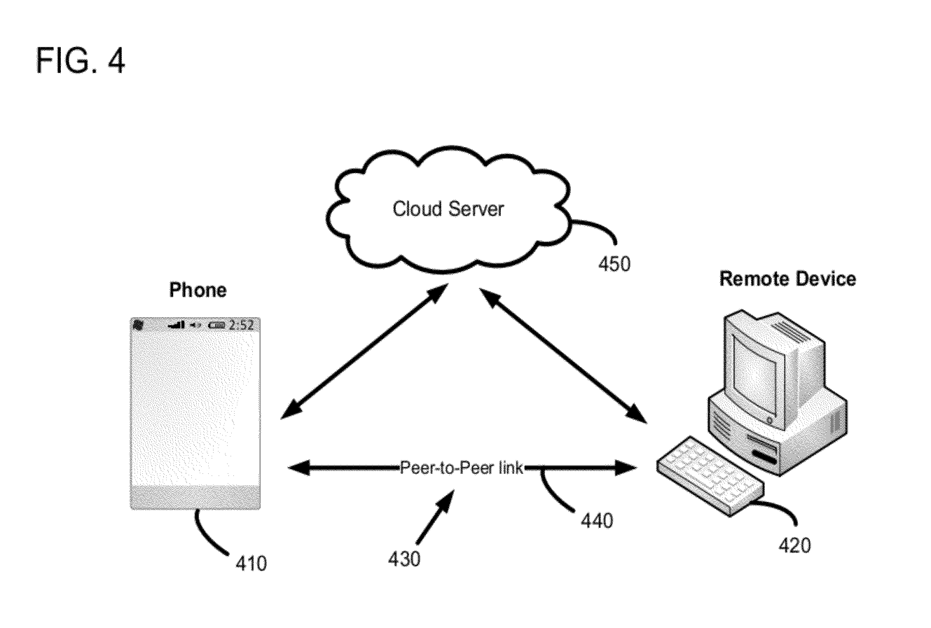

FIG. 4 is an embodiment of a system including a mobile phone 410, as the mobile device and a desktop computer 420, as the remote device. A two-way communication link 430 is established to allow a duplex communication scheme (e.g., full or half duplex). Example duplex communication schemes include a peer-to-peer link, as shown at 440, or through a cloud server, as shown at 450. The cloud server can be any of a variety of networks, such as an Intranet or Internet-based network. Although only one desktop computer 420 is shown, multiple remote devices can be used.

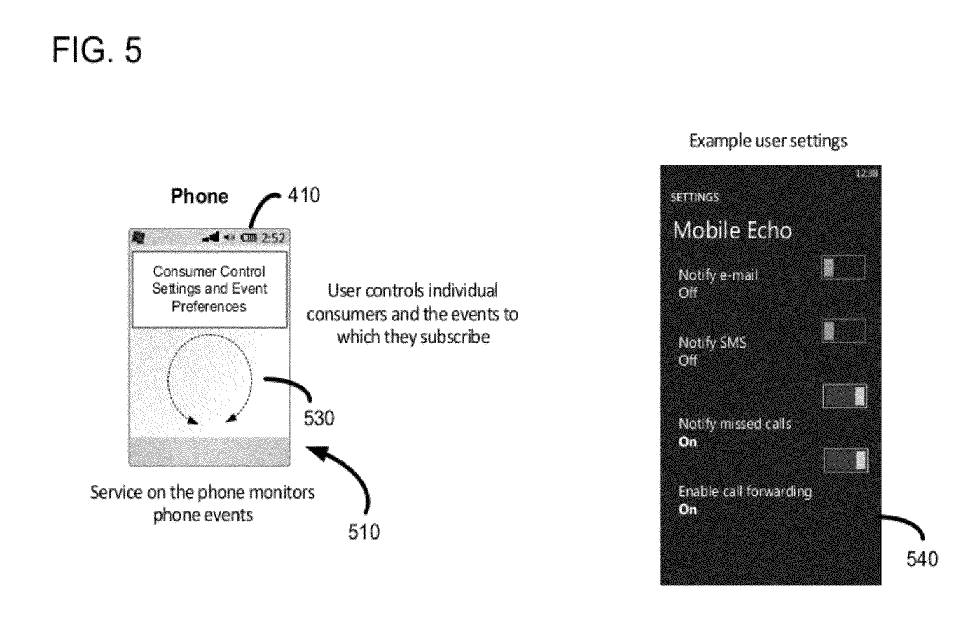

FIG. 5 is an embodiment showing an application 510 on a mobile phone 410. The application 510 monitors phone events as shown diagrammatically at 530 as a continuous loop. An example user interface 540 shows different event settings that can be controlled by the user. For example the user can turn on or off email notification, SMS notification, missed call notification and enablement of call forwarding. Additionally, the user can control such settings for multiple remote devices and each remote device can have a different user interface window 540.

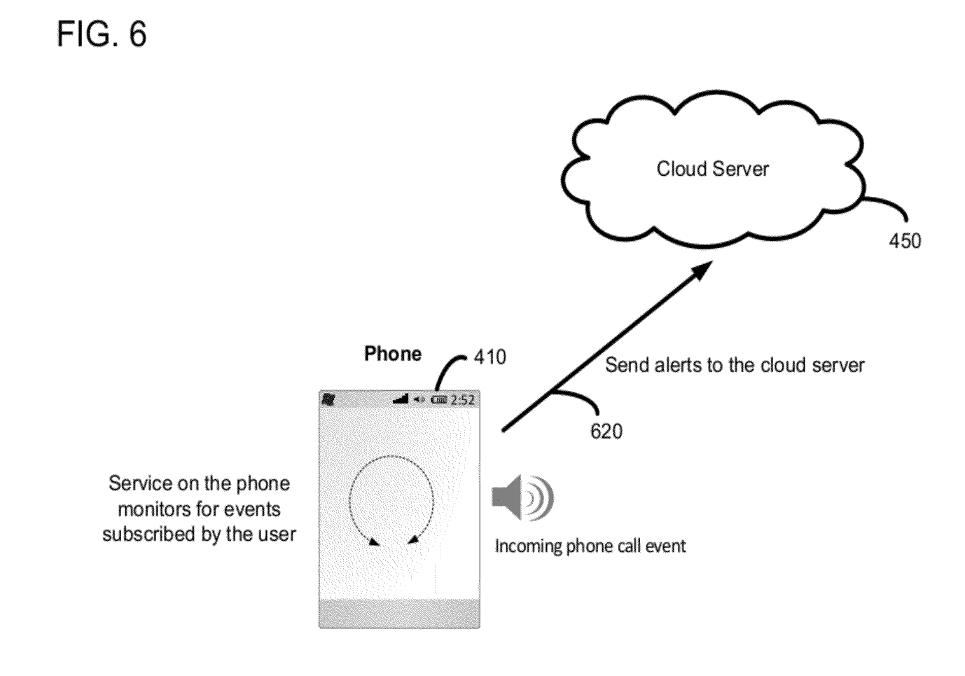

FIG. 6 is an embodiment showing that the phone 410 can detect an incoming event, such as a phone call and upon detection of the event, compares the event to the user interface settings 540. In the case of a received phone call, if “missed calls” is switched on, an alert is generated. In the particular embodiment, the alert is a message 620 sent to a cloud server 450. The alert can be a simple message including information that a phone call event occurred. Additional information can be time/date stamp and caller identification.

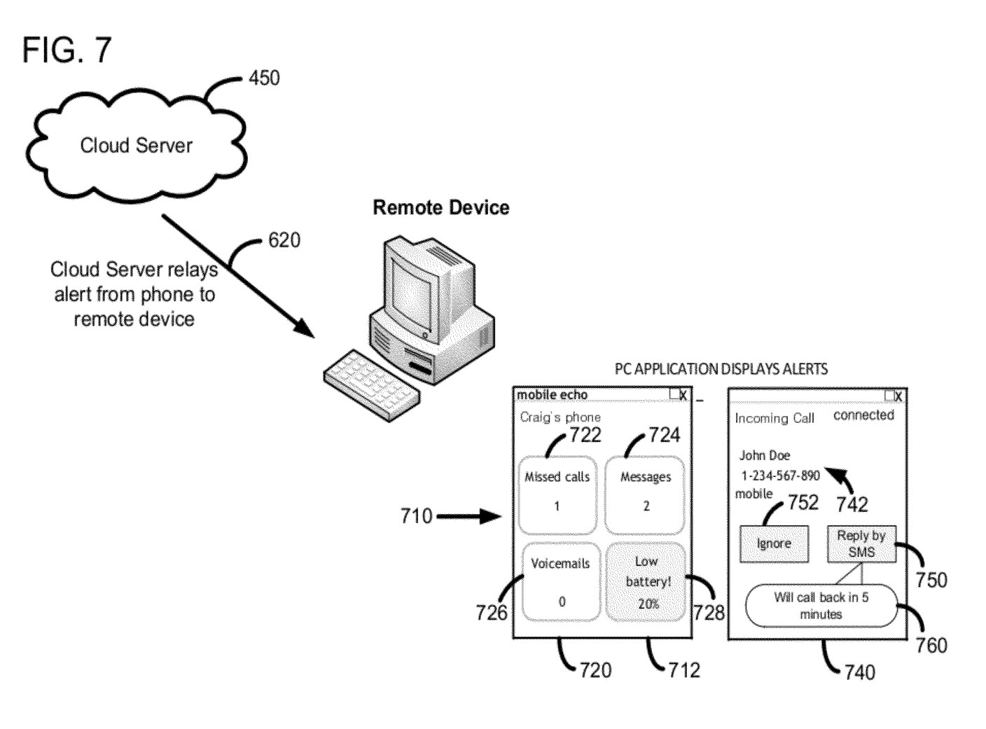

FIG. 7 shows that the cloud server 450 can relay the alert 620 to the remote device 420. The remote device 420 also monitors for incoming alerts. When an alert is received, the remote device 420 can display the alert to the user on the remote device, such as shown in user interface 710. A first window 712 can show an overview of events divided into different categories, such as missed calls 722, messages, 724, voicemails 726, and a low battery indication 728. Other categories can be used. The user can select one of the categories to display a second window 740. This window provides information about the call as shown at 742, which indicates who called and a phone number of the caller. Time and date stamps can also be added. The user can then reply by selecting one or more buttons. For example, button 750 can be selected allowing the user to reply with a text message. Alternatively, button 752 allows the user to ignore the incoming alert. If the user chooses to reply with a text message, the reply is sent from the mobile phone 410, as further described below. The user can type in a reply or automated options can be available, such as shown at 760, where a button is displayed which says “Will call back in 5 minutes.” If the user selects the automated reply, a text message including the automated reply is returned to the person that called. Other automated replies can be generated based on the particular situation.

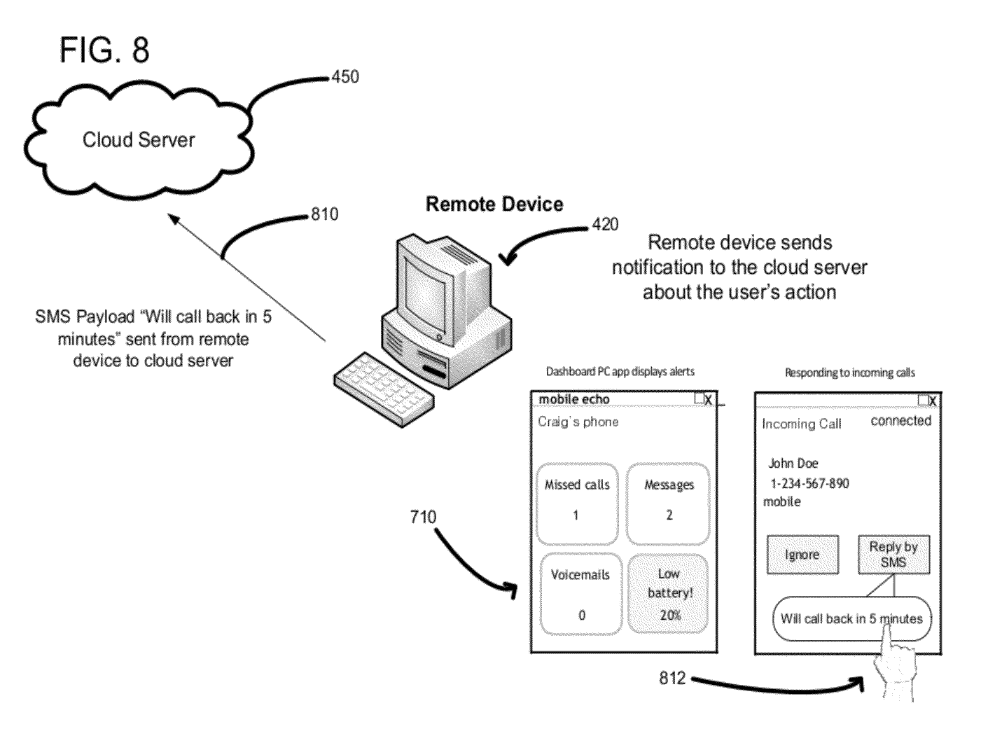

FIG. 8 shows a command 810 can be sent from the remote device 420 to the cloud server 450 based on the user selected response 812 from the user interface 710. The command is an instruction to perform an action on the mobile device. The action can utilize virtually any functionality available on the mobile phone.

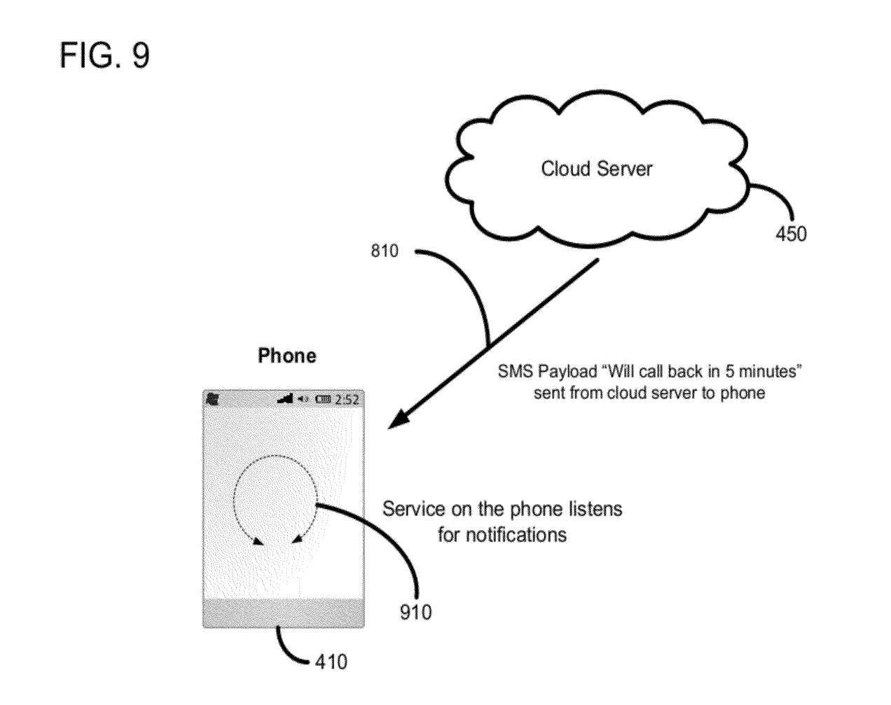

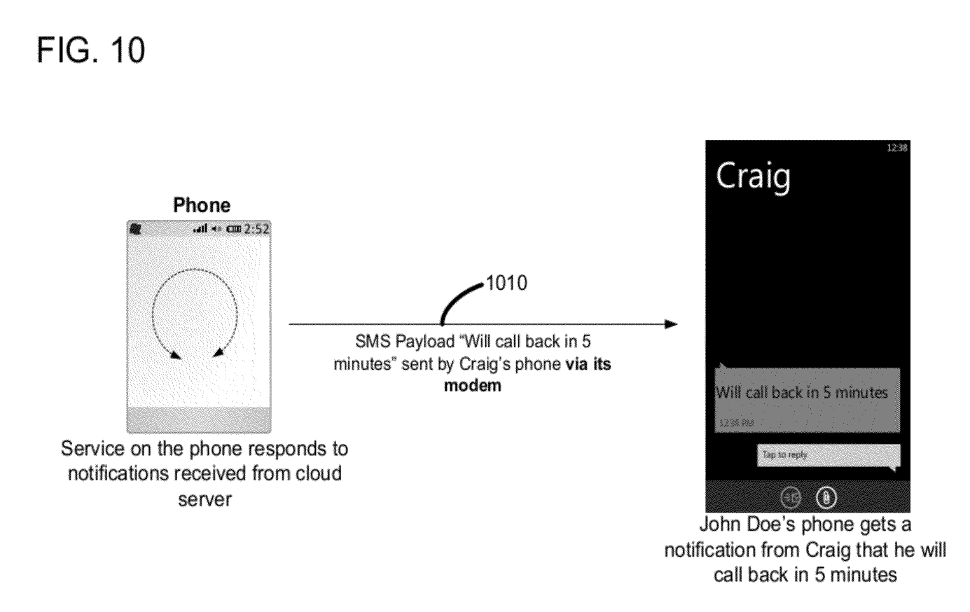

FIG. 9 shows the cloud server 450 delivering the command 810 to the phone 410. The phone 410 monitors for commands from the cloud server 450 and, upon receipt, performs an action associated with the command. FIG. 10 shows an example action performed. In this example, a text message 1010 is sent to the third-party that initiated the call via the phone's modem. This is a desirable capability because it allows even a less capable remote client to simply leverage the capabilities of the phone.

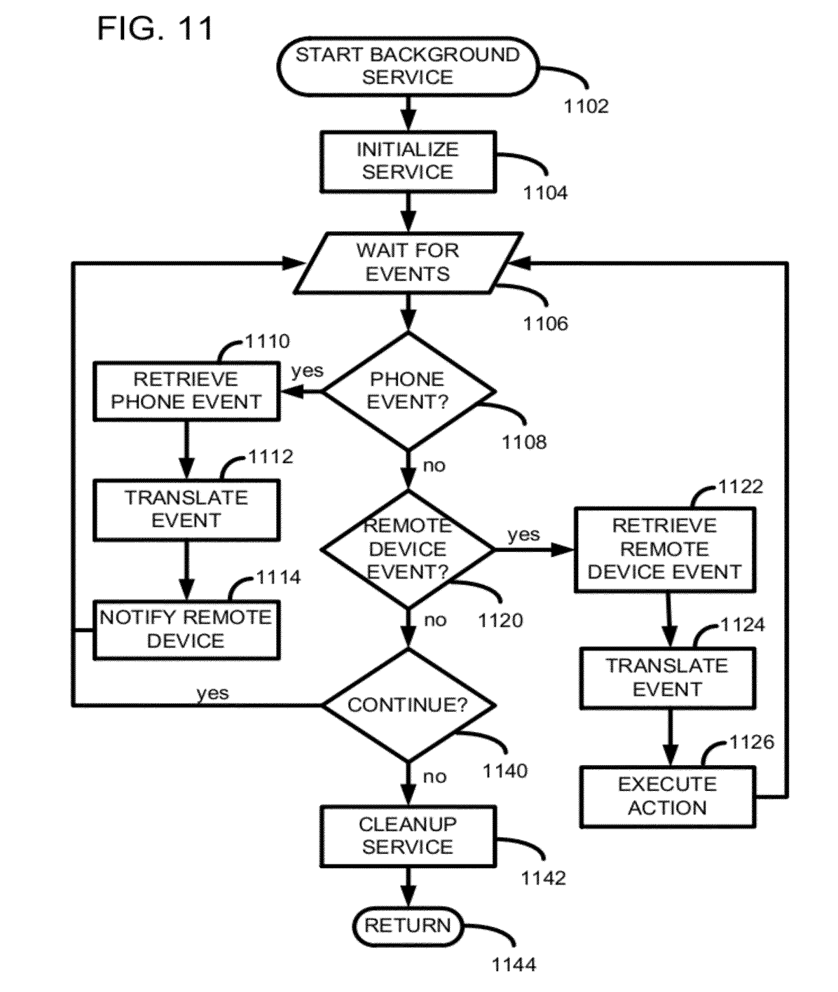

FIG. 11 is a flowchart of a method that can be executed on the mobile device for monitoring for phone events and commands from a remote device. A background service is started in process block 1102. In process block 1104, the service is initialized using stored settings, which can be predetermined or user controlled. In process block 1106, a loop is initiated monitoring for events, which include phone events or command events from a remote device. When an event is detected, in decision block 1108, a check is made whether it is a phone event. If yes, the method continues to process block 1110 wherein the phone event is retrieved. For example, the phone event can be temporarily stored in a buffer and retrieved from the buffer. In process block 1112, the event is translated. The translation relates to interpreting the event so the appropriate event information can be sent to the remote device. In process block 1114, the remote device is notified of the event through a two-way communication link. If decision block 1108 is answered in the negative, then in decision block 1120 a determination is made whether the event is a command from a remote device. If yes, then in process block 1122, the event information is retrieved. In process block 1124, the event is translated into a command to be performed on the mobile device. In process block 1126, the command is executed or performed by completing an action on the phone. An action can be to change settings on the phone or by sending data external to the phone using the cellular modem, such as by sending a text message or email a third party that initiated the event. If decision block 1120 is answered in the negative, a decision is made whether to continue in decision block 1140. If yes, then the routine continues by returning to process block 1106 and waiting for more events. If no, then in process block 1142, a clean-up service is performed and the method ends in process block 1144.

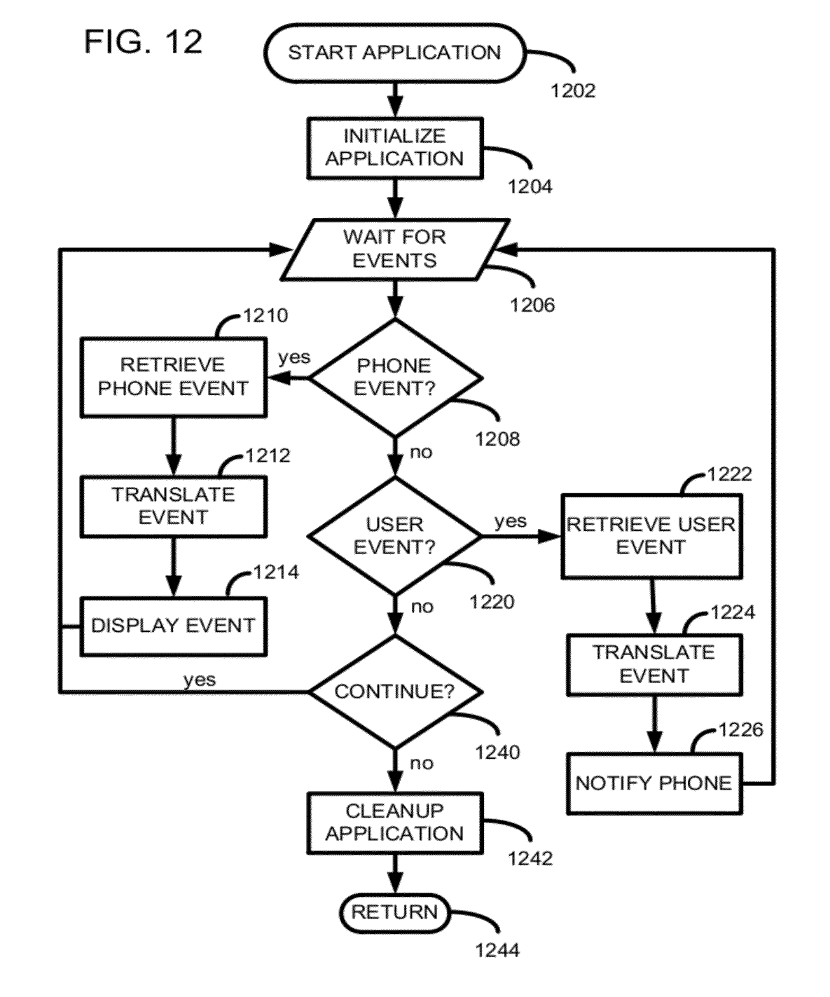

FIG. 12 is a flowchart of a method that can be implemented on a remote device. An application is started in process block 1202. In process block 1204, the application is initialized using stored settings, which can be predetermined or user controlled. In process block 1206, a loop is initiated monitoring for events, which include phone events or events associated with the remote device. When an event is detected, in decision block 1208, a check is made whether it is an event from the phone. If yes, the method continues to process block 1210 wherein the phone event is retrieved. For example, the phone event can be temporarily stored in a buffer and retrieved therefrom. In process block 1212, the event is translated. The translation relates to interpreting the event so the appropriate event information can be displayed to the user. In process block 1214, the event is displayed to the user. For example, if the phone event is an incoming call, information associated with the call is displayed. If decision block 1208 is answered in the negative, then in decision block 1220 a determination is made whether the event is a user event that is entered into the remote device. If yes, then in process block 1222, the event information is retrieved. In process block 1224, the event is translated into a command to be performed on the mobile device. In process block 1226, the phone is notified by sending the command to the mobile device. The phone can then take action based on the command. If decision block 1220 is answered in the negative, a decision is made to continue in decision block 1240. If yes, then the routine continues by returning to process block 1206 and waiting for more events. If no, then in process block 1242, a clean-up service is performed and the method ends in process block 1244.

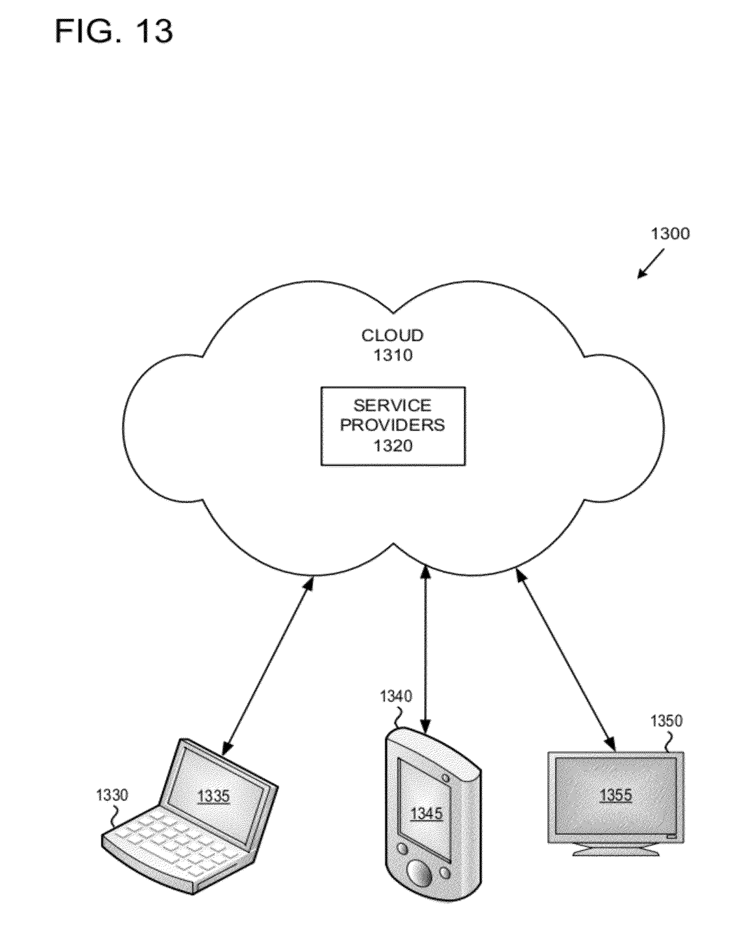

FIG. 13 illustrates a generalized example of a suitable implementation environment 1300 in which described embodiments, techniques, and technologies may be implemented.

In example environment 1300, various types of services (e.g., computing services) are provided by a cloud 1310. For example, the cloud 1310 can comprise a collection of computing devices, which may be located centrally or distributed, that provide cloud-based services to various types of users and devices connected via a network such as the Internet. The implementation environment 1300 can be used in different ways to accomplish computing tasks. For example, some tasks (e.g., processing user input and presenting a user interface) can be performed on local computing devices (e.g., connected devices 1330, 1340, 1350) while other tasks (e.g., storage of data to be used in subsequent processing) can be performed in the cloud 1310.

In example environment 1300, the cloud 1310 provides services for connected devices 1330, 1340, 1350 with a variety of screen capabilities. Connected device 1330 represents a device with a computer screen 1335 (e.g., a mid-size screen). For example, connected device 1330 could be a personal computer, such as desktop computer, laptop, notebook, netbook, or the like. Connected device 1340 represents a device with a mobile device screen 1345 (e.g., a small size screen). For example, connected device 1340 could be a mobile phone, smart phone, personal digital assistant, tablet computer, and the like. Connected device 1350 represents a device with a large screen 1355. For example, connected device 1350 could be a television screen (e.g., a smart television) or another device connected to a television (e.g., a set-top box or gaming console) or the like. One or more of the connected devices 1330, 1340, 1350 can include touch screen capabilities. Touchscreens can accept input in different ways. For example, capacitive touchscreens detect touch input when an object a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 1300. For example, the cloud 1310 can provide services for one or more computers (e.g., server computers) without displays.

Services can be provided by the cloud 1310 through service providers 1320, or through other providers of online services (not depicted). For example, cloud services can be customized to the screen size, display capability, and/or touch screen capability of a particular connected device (e.g., connected devices 1330, 1340, 1350).

In example environment 1300, the cloud 1310 provides the technologies and solutions described herein to the various connected devices 1330, 1340, 1350 using, at least in part, the service providers 1320. For example, the service providers 1320 can provide a centralized solution for various cloud-based services. The service providers 1320 can manage service subscriptions for users and/or devices (e.g., for the connected devices 1330, 1340, 1350 and/or their respective users).

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method of communicating using a mobile device, comprising:
receiving an event on a mobile device;
using a two-way communication link, automatically communicating the event from the mobile device to a remote client without user intervention;
using the two-way communication link, receiving a command to control the mobile device from the remote client; and
automatically performing the command to control the mobile device in order to leverage capabilities available on the mobile device

2. The method of claim 1, further including running an application on the mobile device that monitors events and automatically broadcasts the occurrence of an event to the remote client.

3. The method of claim 1, further including pairing and authenticating the remote client to establish the two-way communciation link.

4. The method of claim 1, further including displaying the event on the remote client.

5. The method of claim 1, wherein the event includes receiving a phone call or a text message from a third-party device.

6. The method of claim 1, wherein performing the command to control the mobile device includes changing settings of the mobile device.

7. The method of claim 1, wherein automatically performing the command includes using a cellular modem on the mobile device to communicate a message to a third-party device.

8. The method of claim 1, wherein the two-way communication link is a peer-to-peer communication link or an Internet-based communication link.

9. A method of communicating using a mobile device, comprising:
establishing a two-way communication link between a mobile device and a remote computer;
monitoring in the mobile device for events in accordance with user settings;
in response to detecting an event, sending an alert to the remote computer;
receiving from the remote computer, an instruction to perform an action on the mobile device; and
in response to receiving the instruction, performing the action on the mobile device without user input at the mobile device to use capabilities of the mobile device

10. The method of claim 9, wherein the two-way communication link is peer-to-peer or through a network server.

11. The method of claim 9, wherein the mobile device is a mobile phone having a cellular antenna and a modem and the remote computer is a desktop computer.

12. The method of claim 9, wherein the user settings include one or more of the following: notification of email; notification of a text message, notification of battery status, notification of location and network information, notification of missed calls, and enable call forwarding.

13. The method of claim 9, further including receiving the alert at the remote computer and displaying the alert to the user.

14. The method of claim 9, wherein sending the alert to the remote computer occurs automatically, without user input.

15. The method of claim 9, wherein performing the action includes sending a text message to a third party through a cellular network.

16. The method of claim 9, further including inputting the action at the remote computer and automatically controlling the mobile device remotely.

17. The method of claim 9, wherein performing the action includes changing the user settings on the mobile device.

18. A method of communicating with a mobile phone, comprising:
establishing a two-way link between the mobile phone and a remote computer using an Internet-based connection;
receiving user settings in the mobile phone related to event detection;
automatically monitoring events in accordance with the user settings and upon detection of an event, sending an alert over the two-way link to the remote computer;
displaying the alert on the remote computer;
receiving input at the remote computer to respond to the alert;
sending a command to the mobile phone through the two-way link, the command related to the input received at the remote computer;
monitoring at the mobile phone for the command; and
automatically performing the command on the mobile phone by leveraging the capabilities available on the mobile device.

19. The method of claim 18, wherein the command includes sending a text message or phone message to a third party using the mobile phone, but automatically without user interaction.

20. The method of claim 18, wherein through sending the command, a user can control settings in the mobile phone remotely.
